(19) United States
(12) Patent Application Publication
(10) Pub. No.: US 2025/0015604 A1
(43) Pub. Date: Jan. 9, 2025

(54) MULTI-BANK MARINE BATTERY CHARGER AND METHOD WITH AUTOMATIC BATTERY VOLTAGE CLASS SELECT

(71) Applicant: Daniel Baston, Saint Peter, MN (US)

(72) Inventor: Daniel Baston, Saint Peter, MN (US)

(73) Assignee: Johnson Outdoors Inc., Racine, WI (US)

(21) Appl. No.: 18/347,267

(22) Filed: Jul. 5, 2023

(51) Int. Cl. H02J 7/00; B60L 53/62

(52) U.S. Cl. CPC H02J 7/0013; B60L 53/62; H02J 7/00041; H02J 7/0045; H02J 7/007182; B60L 2200/32

(57) ABSTRACT

A multi-bank marine battery charger having at least one 12 Vdc charging bank and at least one multi-voltage 24/36 Vdc charging bank, and a method of operating such multi-voltage charging bank, are provided. The method enables the multi-voltage charging bank to, one or more, turn on a fully depleted battery, determine the voltage class of the connected battery, fully charge, and detect completion of the charging of a single 24 or 36 Vdc battery.

### FIELD OF THE INVENTION

This invention generally relates to multi-bank battery chargers, and more particularly to multi-bank lithium battery chargers for marine applications.

### BACKGROUND OF THE INVENTION

As the use of advanced electronics and more powerful electrical propulsion equipment continues to grow, battery manufacturers have responded with new chemistry compositions to provide the increased capacity required by consumers to power such equipment. Indeed, the advances in power capacity and weight management provided by lithium batteries, e.g. LiFePO4 batteries, have enabled the deployment of such electronics and increased propulsion power on platforms that heretofore were limited by the number and weight of batteries needed to provide a serviceable day of use.

A prime example of this may be seen in the recreational marine fishing industry. Indeed, it is not uncommon to find a recreational fishing boat with multiple sonar transducers deployed to enable side imaging, down imaging, 360° imaging around the boat, and live imaging of the fishing environment with target locking capabilities. It is also not uncommon to find multiple fish finder, mapping, and navigational displays, e.g. the Humminbird® APEX, SOLIX, or HELIX series fish finders available from the assignee of the instant application, deployed in multiple locations on the boat to enable viewing and use of the information from and control of such multiple systems at the same time and while fishing or piloting the boat at different locations. Indeed, such systems are often networked together, e.g. via the One-Boat Network® system also available from the assignee.

Because the recreational fishing industry utilizes a 12 Vdc power system to power such accessory equipment, as more such electronic equipment is deployed on the boat, battery manufactures have responded with larger capacity 12 Vdc batteries to provide capability for such use on a full day a fishing. Indeed, in order to achieve the desired run time of such equipment, some anglers choose instead to wire multiple lower capacity 12 Vdc batteries in parallel to achieve the same increased run time needed during a full day of fishing.

In addition to the increased deployment of such advanced electronic accessories, most recreational fishing boats also have an electric trolling motor, e.g. a Minn Kota© Ultrex, Ulterra, or Terrova series trolling motor available from the assignee of the instant application, to provide propulsion and/or virtual anchoring while fishing. Such trolling motors typically use 12 Vdc, 24 Vdc, or 36 Vdc depending on the size and trust provided thereby. To achieve the operating voltage for the 24 Vdc and 36 Vdc trolling motors, many anglers combine two or three 12 Vdc batteries in series.

In order to charge the numerous 12 Vdc batteries used on the fishing boat with a minimal of effort, multi-bank battery charges are typically used. These multi-bank chargers essentially include multiple 12 Vdc chargers in a single housing that uses a single power input to feed each bank. Each bank is connected to a single 12 Vdc battery in order to enable safe and efficient charging so that the boat is ready for a full day of fishing.

Because the 12 Vdc battery was fairly standard for recreational fishing boat applications based on the size and weight of them and the ability to electrically wire them in different configurations to provide additional run time or higher voltage, the angler could simply pick how many banks would be needed when purchasing a multi-bank charger for the angler's boat. For example, the assignee of the instant application provides several lines of multi-bank 12 Vdc onboard battery chargers having from one to five banks, charging capacities of 6, 10, and 15 amps, and charging algorithms for 12 Vdc lead acid, AGM, and Lithium batteries, e.g. model no. MK 550PCL.

However, with the reduced weight and size of the lithium-based batteries, battery manufacturers have begun to provide 24 Vdc and 36 Vdc batteries to power the 24 Vdc and 36 Vdc trolling motors. Unfortunately, these higher voltage batteries cannot be charged by typical multi-bank 12 Vdc chargers. However, because the other electronic equipment discussed above still utilizes 12 Vdc batteries, such chargers are still required.

What is needed is a multi-bank battery charger that provides 12 Vdc and 24/36 Vdc charging banks, and a method of operating same. Further, to eliminate the need to change chargers if a different size trolling motor is purchased, such a multi-bank battery charger that provides 12 Vdc and 24/36 Vdc charging banks is needed to sense the voltage and apply the proper charging for the deployed battery, even if the battery is depleted. Still further, such a multi-bank battery charger that provides 12 Vdc and 24/36 Vdc charging banks is needed that also charges until complete.

Embodiments of the present invention provides such a multi-bank marine battery charger with automatic voltage select. These and other advantages of the invention, as well as additional inventive features, will be apparent from the description of the invention provided herein.

### BRIEF SUMMARY OF THE INVENTION

In view of the above, embodiments of the invention provide a new and improved multi-bank battery charger and method that provides 12 Vdc and 24/36 Vdc charging banks. Preferred embodiments provide such a multi-bank battery charger and method that provide sensing of the voltage of the connected battery and that applies the proper charging voltage therefor. Further, certain embodiments of the present invention provide such identification and charging even to fully depleted batteries at the correct level. Still further, certain embodiments provide automatic detection of completion of the charging cycle.

In one embodiment of the present invention, the multi-bank charger operated in a Constant Current Constant Voltage (CCCV) mode. In this embodiment the maximum output current and maximum output voltage of the charger are set and fixed. When a discharged battery is connected to the charger, the voltage is lower than the max charger voltage. This causes the charger output to be pulled down to the voltage on the battery and the charger outputs maximum current. The battery voltage will then rise and when the battery reaches the charger maximum voltage the voltage will be held on the battery. At this point charger output current begins to fall.

In accordance with a preferred embodiment, the method of the present invention first measures that connected battery voltage. If voltage is less than 2V then the method turns on a 250 mA current source for a preset period of time, e.g., 1 second. The method then checks the voltage to determine if battery is turned on. If the battery did not turn on, then this step is repeated a number of times, e.g., three times. If the battery does not turn on after all of these attempts, then the method will generate an Error message. The method will prevent any further charging attempts. In certain embodiments, a charger reset or power cycle will clear the error and allow further attempts.

If the prior step was successful in turning on the battery, then in an embodiment, the method will apply a maximum current charge, e.g., of 2 amps in one embodiment. The method will then wait a fixed amount of time, e.g., 1 or 2 minutes in certain embodiments. During this time the battery voltage is allowed to float up and stabilize. This happens rather quickly and will be relatively close to the final charger voltage, i.e., 24 or 36 Vdc.

Thereafter in certain embodiments, the method will then measure the battery voltage in order to determine the maximum Constant Voltage (CV) value, e.g., 24 or 36 Vdc, which is then stored in memory and used as the charger is operated in CCCV mode. This mode is continued for a predetermined period in one embodiment, e.g., ten minutes or longer. When the charger output current decreases to 1 A or less, the method determines that the charging process has completed.

Particular advantages provided by certain embodiments of the present invention are the 24/36 Vdc automatic detection and automatic charge completion detection. In a preferred embodiment this process applies a small current and allows the battery to float to its nominal value. This nominal value is then used to set the target for the charging process, e.g., 24 Vdc or 36 Vdc in one embodiment. The method monitors the charging current and determines that the charging is complete upon detection of a charging current drop.

In one embodiment of the present invention, a multi-bank charger includes at least one 12 Vdc charging bank and at least one 24/36 Vdc automatic voltage detecting and charging bank. In a preferred embodiment of this multi-bank charger, the automatic charge complete detection monitors the charging current and determines that the charging is complete when the BSM in the lithium battery stops accepting current from the charger.

In a preferred embodiment, a charger with one 12 Vdc (single battery) bank and one 24/36 Vdc (single battery) bank that can auto-select the correct voltage of the battery connected for charging is provided. Preferably, the charger is a multi-bank Li-ion battery charger. The first bank is dedicated to a 12 Vdc charger. The second bank will charge either a single 24 Vdc battery or a single 36 Vdc battery. This second bank will automatically determine the voltage of the single battery connected thereto and thereafter charge to the correct voltage of that connected battery. This second bank will continue charging until the charging cycle is complete, e.g., until the charging current drops to 1 A or less.

In such an embodiment the autodetect process operates by (a) applying a small current and (b) allowing the battery to float to its nominal value. This float value is used to identify the correct battery voltage (24 Vdc or 36 Vdc) for the charging process. Specifically, the process starts by applying a maximum 2 A charging signal to the battery. The process then waits a predetermined period of time, e.g., 1 or 2 minutes. During this predetermined period of time the battery voltage will float up and stabilize. The battery voltage stabilization happens quickly and will be relatively close to the final charged battery voltage range. This setting may be used as a backup safety for charging the battery so that it does not become over voltage and turn off the battery management system (BMS).

After the predetermined period of time in such an embodiment, the battery voltage is measured. Based on the voltage measured in that prior step, the correct charge output is determined, i.e., 24 Vdc or 36 Vdc voltage range. Once the connected battery voltage is known, the maximum Constant Voltage (CV) value is set in the charging software and used in the charging process.

In such an embodiment of the present invention, the charging process operates in a CCCV mode, wherein the maximum output current and maximum output voltage of the charger are set and fixed. When a user connects a discharged battery the voltage is lower than the max charger voltage. This causes the charger output to be pulled down to the voltage on the battery and the charger outputs maximum current. The battery voltage will then rise and when the battery reaches the charger maximum voltage as determined previously, that voltage will be held on the battery. Once charged, the charger output current begins to fall.

In certain embodiments of the present invention, an automatic charge complete process is also included. Such process monitors the charging current to identify a drop in value as discussed above. This drop identifies when the charging process is completed.

In a preferred embodiment of the present invention, an on-board multi-bank marine battery charger for a recreational fishing boat having installed thereon at least one 12 Vdc battery to power marine electronics and at least one 24 Vdc or 36 Vdc battery to power a trolling motor, includes a housing configured to mount on the recreational fishing boat, at least one single voltage charging bank positioned within the housing and configured to charge one of the at least one 12 Vdc battery, and at least one multi-voltage charging bank positioned within the housing and configured to charge one of the at least one 24 Vdc or 36 Vdc battery.

In one embodiment the at least one multi-voltage charging bank is configured to determine a battery voltage class of the 24 Vdc or 36 Vdc battery when connected thereto. Preferably, the charging bank is configured to determine a battery voltage class by applying a constant current signal to the 24 Vdc or 36 Vdc battery when connected thereto and by measuring a voltage thereof after a predetermined period and comparing the voltage to a predetermined threshold for each battery voltage class. In one embodiment the constant current is 2 A. In one embodiment the predetermined period is one minute. Preferably, the predetermined threshold for a 24 Vdc battery class is between 16 Vdc and 30 Vdc, and the predetermined threshold for a 36 Vdc battery class is between 32 Vdc to 48 Vdc.

In one embodiment the multi-voltage charging bank is configured to determine that the battery voltage class of the 24 Vdc or 36 Vdc battery connected thereto is 24 Vdc when the measured voltage thereof is greater than 18 Vdc and less than 30 Vdc. In an embodiment, the multi-voltage charging bank is configured to charge the 24 Vdc or 36 Vdc battery at 10 A and 29.2 Vdc when the battery voltage class is determined to be 24 Vdc.

In an embodiment, the multi-voltage charging bank is configured to determine that the battery voltage class of the 24 Vdc or 36 Vdc battery connected thereto is 36 Vdc when the measured voltage thereof is greater than 30 Vdc. In an embodiment, the multi-voltage charging bank is configured to charge the 24 Vdc or 36 Vdc battery at 10 A and 45 Vdc when the battery voltage class is determined to be 36 Vdc.

In one embodiment the multi-voltage charging bank is configured to turn on the 24 Vdc or 36 Vdc battery when a sensed voltage of the battery connected thereto is less than a predetermined threshold, preferably 2 Vdc. In an embodiment the multi-voltage charging bank is configured to turn on the 24 Vdc or 36 Vdc battery by providing a current pulse thereto until the sensed voltage is above the predetermined threshold, but preferably not more than a predetermined number of times.

In an embodiment, the multi-voltage charging bank is configured to charge the 24 Vdc or 36 Vdc battery until a charging current drops to below 1 A, at which point the multi-voltage charging bank is configured to indicate that charging is complete.

In another embodiment, a method for an on-board multi-bank marine battery charger for a recreational fishing boat having installed thereon at least one 12 Vdc battery to power marine electronics and at least one 24 Vdc or 36 Vdc battery to power a trolling motor, the multi-bank marine battery charger having a housing configured to mount on the recreational fishing boat, at least one single voltage charging bank positioned within the housing and configured to charge one of the at least one 12 Vdc battery, and at least one multi-voltage charging bank positioned within the housing and configured to charge one of the at least one 24 Vdc or 36 Vdc battery, includes the steps of determining a battery voltage class of the one of the at least one 24 Vdc or 36 Vdc battery when connected thereto, and thereafter charging the one of the at least one 24 Vdc or 36 Vdc battery at a predetermined voltage and current appropriate for the battery voltage class from the step of determining.

In one embodiment the step of determining a battery voltage class includes the steps of applying a constant current signal to the 24 Vdc or 36 Vdc battery, measuring a voltage of the 24 Vdc or 36 Vdc battery after a predetermined period, and comparing the voltage to a predetermined threshold for each battery voltage class. Preferably, the step of determining determines that the battery voltage class is 24 Vdc when the voltage from the step of measuring is greater than 16 Vdc and less than 30 Vdc, and that the battery voltage class is 36 Vdc when the voltage from the step of measuring is greater than 32 Vdc and less than 48 Vdc.

In another embodiment the method also includes the steps of sensing a voltage of the 24 Vdc or 36 Vdc battery, comparing the voltage to a predetermined threshold, and applying a current pulse to the 24 Vdc or 36 Vdc battery until the voltage rises above the predetermined threshold.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a process flow diagram illustrating an embodiment of the automatic charging voltage detection and automatic charging complete processes of the present invention;

FIG. 2 is a graphical illustration of an embodiment of the method of the present invention for a lithium (LiFePO₄) battery; and

FIG. 3 is an isometric illustration of a multi-bank battery charger constructed in accordance with an embodiment of the present invention.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

Turning now to the drawings, there is illustrated a process flow diagram of an automatic voltage detection and charging complete process of an embodiment of the present invention. Such a process finds particular applicability to a multi-bank marine charger for use on or with a recreational fishing boat that operates with both 12 Vdc and either a 24 Vdc or a 36 Vdc battery to power certain accessory electronics and a trolling motor installed thereon. While one embodiment of such multi-bank charger includes a single bank for the 12 Vdc battery and a single bank for the 24 Vdc or 36 Vdc battery, other embodiments may include multiple charging banks for such batteries in various combinations, e.g., multiple 12 Vdc banks and a single 24/36 Vdc bank, a single 12 Vdc bank and multiple 24/36 Vdc banks, multiple 12 Vdc and multiple 24/36 Vdc banks, etc.

Further, in certain embodiments, only a single 24/36 Vdc bank is provided and operated in accordance with an embodiment of the process of the present invention having automatic charging voltage detection and/or the automatic charging complete detection. Still further, multiple banks of the 24/36 Vdc chargers are included in an alternate embodiment as the multi-bank charger.

In other embodiments, the multiple voltage charging banks may be a 12/24 Vdc charging bank, a 12/24/36 Vdc charging bank, a 12/36 Vdc charging bank, etc. Such embodiments may also utilize an embodiment of the automatic voltage detection process, the automatic charging complete process, or combinations thereof, and may be combined with one or more single voltage charging banks. Indeed, the particular voltage of the charging banks is not limited to 12, 24, or 36 Vdc, but may be any voltage to accommodate commercial or specialty battery voltages.

As will also be appreciated by those skilled in the art from the foregoing and following description, such batteries may be for any application and use any construction having similar voltage and/or current characteristics that enable use of an embodiment of the processes of the present invention. As such, the descriptions contained herein should be taken by way of example and not by way of limitation.

The foregoing notwithstanding, the following description will discuss an embodiment of the present invention that is directed to a multi-bank Li-ion battery charger for use on a recreational fishing boat, such as discussed in the Background of the Invention section, above. The first charging bank is dedicated to a 12 Vdc battery charger. The second charging bank is a multi-voltage charging bank that will charge either a single 24 Vdc battery or a single 36 Vdc battery. This second bank will automatically determine the voltage of the single battery connected thereto, even if fully discharged upon connection thereto, and thereafter will charge to the correct voltage without exceeding a safe level for this class of battery. Preferably, this charging will continue until the charging cycle is complete.

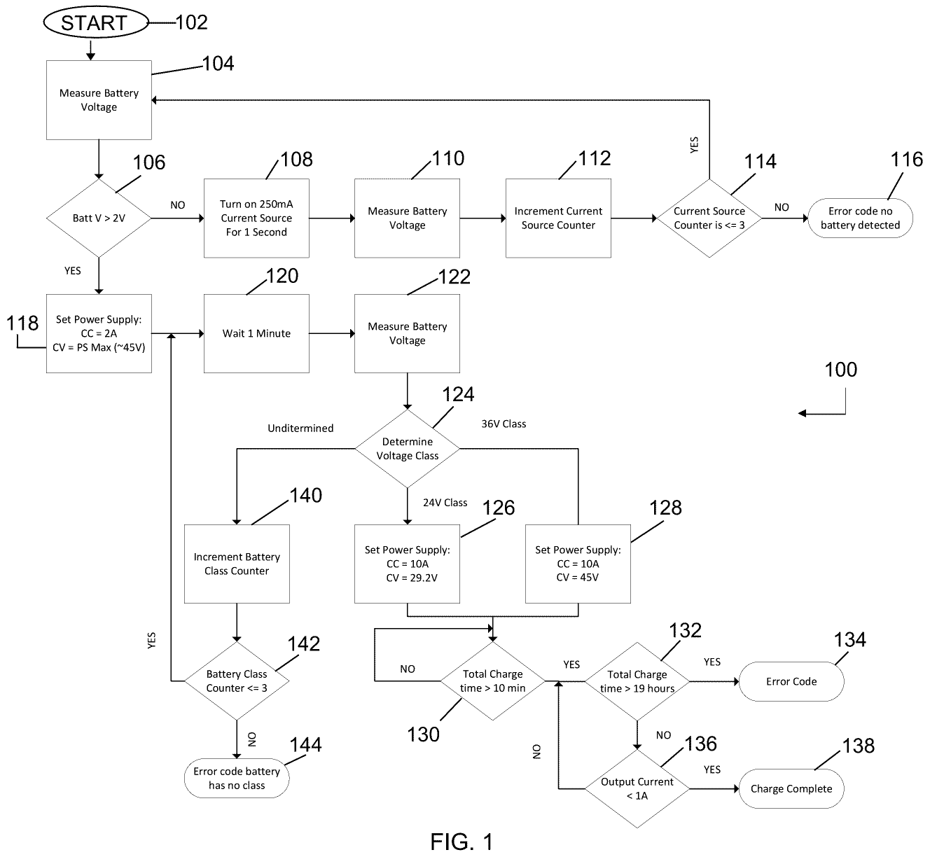

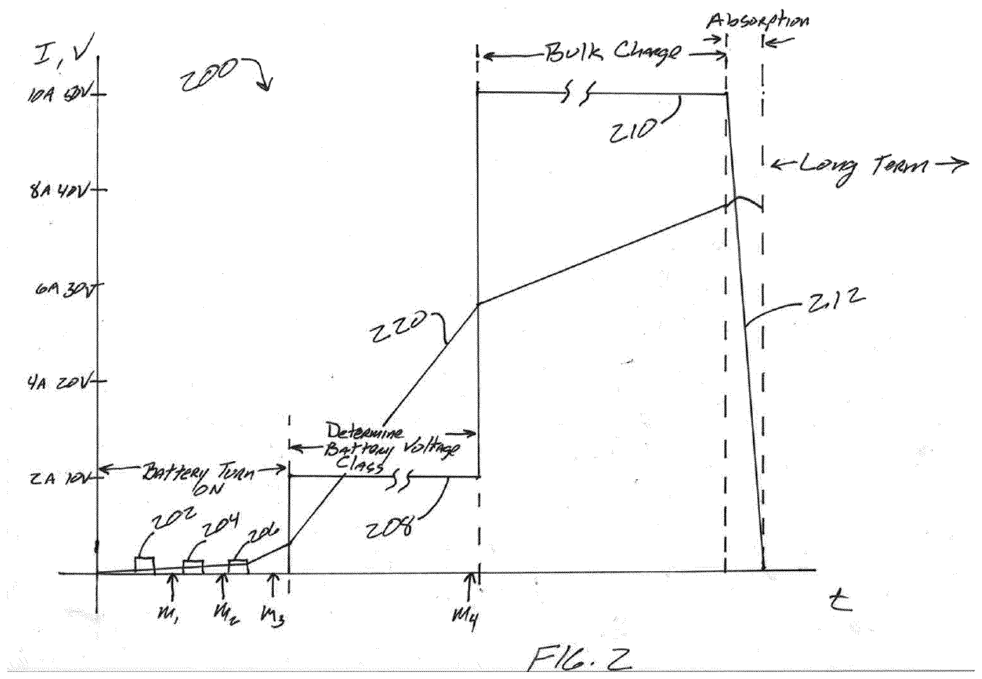

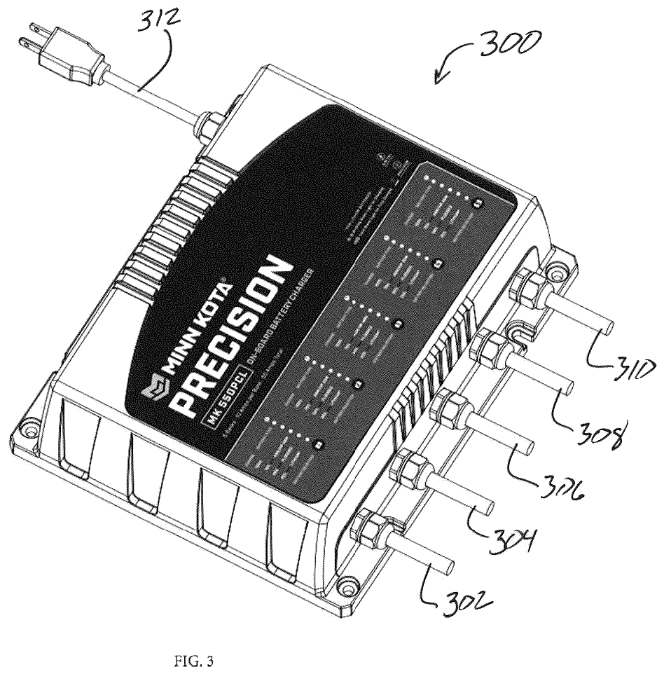

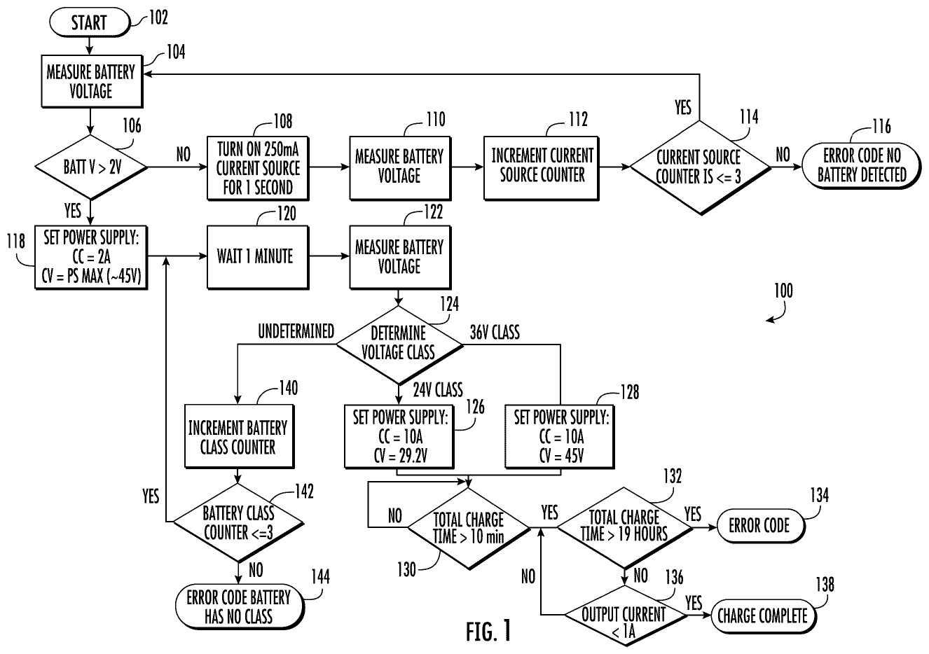

Turning now specifically to FIG. 1, there is illustrated an embodiment of the charging method 100 implemented for the multi-voltage charging bank of the multi-bank battery charger of the present invention. In the illustrated embodiment, the multi-voltage charging bank is a 24/36 Vdc charging bank that can charge a single 24 Vdc battery or a single 36 Vdc battery.

Once the user has connected a single battery to the charging cable of the multi-voltage battery charging bank, the process starts at step 102. Because the battery that has been connected may be fully discharged, the method 100 first measures the connected battery voltage at step 104. If the battery voltage is less than 2 Vdc as determined at step 106, the method 100 first attempts to determine whether the battery can accept a charge. During this initial battery turn on phase, the method 100 provides a small current charge, e.g., 250 mA, for a predetermined period, e.g., one second, at step 108. Thereafter, at step 110, the method 100 measures the battery voltage, and increments the current source counter at step 112. The current source counter is then checked at step 114 to ensure that only an appropriate number of attempts are made before determining that there is an error, or that no battery is connected as indicated at termination 116.

If the number of wake-up attempts is less than the pre-set value, e.g. three, at step 114, then the battery voltage is again measured at step 104 to determine whether it has now risen above the predetermined threshold at step 106. If the battery voltage is still below the threshold, another attempt will be made at waking up the battery by processing steps 108, 110, 112, and 114. Assuming that the number of attempts has not been exhausted as determined by step 114, the attempts to wake up the battery may continue until step 106 determines that the battery voltage is greater than the predetermined threshold.

Once it has been determined that a battery is connected and may be capable of receiving charge at this step 106, the process then sets the charging module to a constant current mode at step 118 at a modest level of current in an attempt to determine the battery voltage class of the battery connected thereto. It should be noted that during this battery voltage class determination phase, the charging module output voltage control is set to maximum for the particular configuration of the charging module at this step 118. In an embodiment that is capable of charging 12 Vdc, 24 Vdc, or 36 Vdc batteries, this value may be, for example, 45 Vdc. In one embodiment when the constant current being supplied at 2 A, if the PS Max threshold is reached, then the charging process 100 is terminated as such may be indicative of a fault. In an embodiment it is also possible to detect the presence of a load on the battery and adjust the constant charging current to accommodate, or to set a constant current value at a higher level, e.g. 4 A. In such an embodiment, the time set in step 120, to be discussed below, may also be adjusted to allow for proper charging while supplying the external load.

Once the constant current mode has been entered at step 118, the process waits a predetermined period of time, e.g. one minute, at step 120 before measuring the battery voltage at step 122. Step 124 then determines the voltage class based on the measurement taken at step 122. For lithium-based batteries, the charging step 118 for the period of step 120 will result in the output voltage of the battery rising quickly and close to its rated voltage, and therefore the determination of the voltage class at step 124 utilizes threshold values for each class. In one embodiment, a voltage reading between approximately 9 Vdc and 15 Vdc will be identified as the 12 V class (not shown in the embodiment of FIG. 1 but may be included as discussed above), a voltage reading between approximately 16 Vdc and 30 Vdc will be identified as the 24 V class, and a voltage reading between approximately 32 Vdc and 48 Vdc will be identified as the 36 V class.

If the determined voltage class from step 124 indicates that a 24 Vdc battery is connected to the charging module, then step 126 sets the constant current charging module to 10 A with a constant voltage set at 29.2 Vdc. If, however, the determination step 124 identifies the battery as being a member of the 36 Vdc class, then step 128 sets the constant current to 10 A with a constant voltage set at 45 V.

Regardless of the particular class of battery, the method 100 continues at step 130 to allow a minimum total charge time, e.g., 10 minutes in one embodiment. Once this charge time has exceeded the threshold as determined by step 130, the method 100 then begins to monitor the output current for a drop that signifies charge completion within a maximum charge time expected. In other embodiments, step 130 (and step 132 discussed below) is optional, i.e. the monitoring of the output current for a drop is not delayed (or limited) in time.

Specifically, step 132 sets a total maximum charge time and monitors expiration thereof, while step 136 monitors the output current to determine whether it has dropped below 1 A. Such a drop indicates a successful charge completion that allows the method 100 to end at termination 138. If, however, the total charge time exceeds 19 hours before the output current drops below 1A, then an error code is generated at termination 134 indicating that the battery was not successfully charged within a typical charge time.

If the method 100 were unable at step 124 to determine the battery voltage class, the process increments a battery class counter at step 140, and checks to see whether a predetermined number of checks have been exhausted. If the predetermined number of attempts at classifying the battery class have not been exhausted, the process returns to step 120 to allow the 2A charging process to continue for another preset period of time before the battery voltage is again measured at step 122. If the battery class still cannot be determined at step 124 after the battery class counter has exceeded the number of attempts set, then the process issues an error code identifying that the battery voltage class cannot be determined at termination 144.

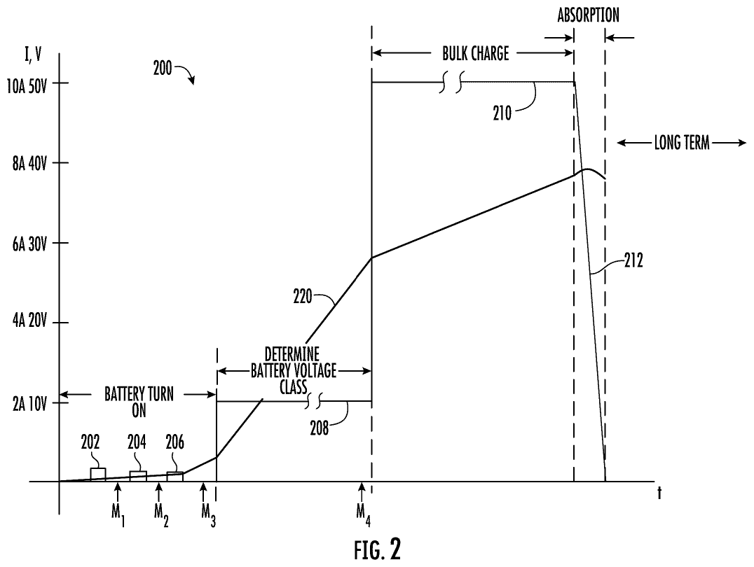

With this charging method 100 now in mind, attention is directed to the graphical representation of FIG. 2. This FIG. 2 illustrates a simplified current and voltage graph 200 simulating operation during each of the above-described phases of the overall method. This graphical illustration assumes the connection of a fully depleted battery and the need to provide multiple current pulses 202, 204, 206 during the battery turn on phase before the sensed voltage at times M₁, M₂, and M₃ before the voltage level 220 rises above the set threshold, e.g. 2 Vdc.

Of course, from the preceding those skilled in the art will understand that fewer such current pulses may be required depending on the state of the battery charge upon initial connection to the charging module. Indeed, as will be recalled from steps 104 and 106 shown in FIG. 1, if the initial battery voltage is greater than the threshold, the battery turn on phase may be skipped in its entirety. In such case, the process simply moves to the determination of the battery voltage class phase by increasing the constant current level to 2 A as indicated in FIG. 2 as level 208.

As discussed above, during this voltage class determination process phase, the battery voltage 220 will rise rather quickly to near its battery voltage class level. Indeed, the measurement at time M₄ (corresponding to step 122 of FIG. 1) is assumed in FIG. 2 to successfully identify the appropriate voltage class of the connected battery. In the illustration of FIG. 2, the connected battery is illustrated to be in the 36 Vdc class and will be charged at 10 A as indicated at 210 during the bulk charge phase of the process.

FIG. 2 also illustrates along current level 212 completion of the battery charging, which is characterized by a rapid drop of the charging current to less than 1A during this absorption phase.

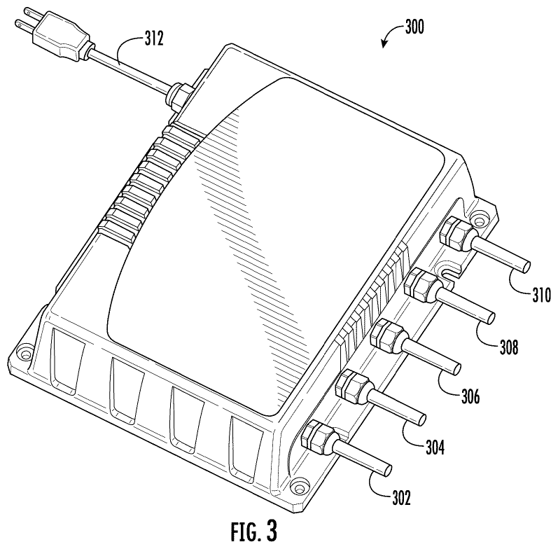

As noted above, the charging process discussed above may be implemented in various embodiments of a multi-bank battery charger. One such embodiment is illustrated in FIG. 3 as the five-bank precision onboard battery charger 300. Each of the individual charging banks include their own output wiring 302, 304, 306, 308, 310, that each may be connected to a single battery. As discussed above, such individual charging banks may be single voltage banks, e.g. 12 Vdc, or may be multiple voltage charging banks, e.g. 24/36 Vdc that utilize an embodiment of the method of the present invention as discussed above.

The input power for such multi-bank batteries chargers 300 may be an AC input 312 that enables charging of the batteries on the boat when it is trailered and taken home, at the marina in storage, or at the dock if shore power is available. Other embodiments may utilize an onboard alternator or inverter, and such models are available from the assignee of the instant application.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. An on-board multi-bank marine battery charger for a recreational fishing boat having installed thereon at least one 12 Vdc battery to power marine electronics and at least one 24 Vdc or 36 Vdc battery to power a trolling motor, comprising:
a housing configured to mount on the recreational fishing boat;
at least one single voltage charging bank positioned within the housing and configured to charge one of the at least one 12 Vdc battery;
at least one multi-voltage charging bank positioned within the housing and configured to charge one of the at least one 24 Vdc or 36 Vdc battery.

2. The on-board multi-bank marine battery charger of claim 1, wherein the at least one multi-voltage charging bank is configured to determine a battery voltage class of the one of the at least one 24 Vdc or 36 Vdc battery when connected thereto.

3. The on-board multi-bank marine battery charger of claim 2, wherein the at least one multi-voltage charging bank is configured to determine a battery voltage class by applying a constant current signal to the one of the at least one 24 Vdc or 36 Vdc battery when connected thereto and by measuring a voltage thereof after a predetermined period and comparing the voltage to a predetermined threshold for each battery voltage class.

4. The on-board multi-bank marine battery charger of claim 3, wherein the constant current is 2 A.

5. The on-board multi-bank marine battery charger of claim 3, wherein the predetermined period is one minute.

6. The on-board multi-bank marine battery charger of claim 3, wherein the predetermined threshold for a 24 Vdc battery class is 16 Vdc to 30 Vdc.

7. The on-board multi-bank marine battery charger of claim 3, wherein the predetermined threshold for a 36 Vdc battery class is 32 Vdc to 48 Vdc.

8. The on-board multi-bank marine battery charger of claim 3, wherein the at least one multi-voltage charging bank is configured to determine the battery voltage class of the one of the at least one 24 Vdc or 36 Vdc battery connected thereto is 24 Vdc when the measured voltage thereof is greater than 18 Vdc and less than 30 Vdc.

9. The on-board multi-bank marine battery charger of claim 8, wherein the at least one multi-voltage charging bank is configured to charge the one of the at least one 24 Vdc or 36 Vdc battery at 10 A and 29.2 Vdc when the battery voltage class is determined to be 24 Vdc.

10. The on-board multi-bank marine battery charger of claim 3, wherein the at least one multi-voltage charging bank is configured to determine the battery voltage class of the one of the at least one 24 Vdc or 36 Vdc battery connected thereto is 36 Vdc when the measured voltage thereof is greater than 30 Vdc.

11. The on-board multi-bank marine battery charger of claim 10, wherein the at least one multi-voltage charging bank is configured to charge the one of the at least one 24 Vdc or 36 Vdc battery at 10 A and 45 Vdc when the battery voltage class is determined to be 36 Vdc.

12. The on-board multi-bank marine battery charger of claim 1, wherein the at least one multi-voltage charging bank is configured to turn on the one of the at least one 24 Vdc or 36 Vdc battery when a sensed voltage of the battery connected thereto is less than a predetermined threshold.

13. The on-board multi-bank marine battery charger of claim 12, wherein the predetermined threshold is 2 Vdc.

14. The on-board multi-bank marine battery charger of claim 13, wherein the at least one multi-voltage charging bank is configured to turn on the one of the at least one 24 Vdc or 36 Vdc battery by providing a current pulse thereto until the sensed voltage is above the predetermined threshold.

15. The on-board multi-bank marine battery charger of claim 13, wherein the at least one multi-voltage charging bank is configured to provide the current pulse no more than a predetermined number of times.

16. The on-board multi-bank marine battery charger of claim 1, wherein the at least one multi-voltage charging bank is configured to charge the one of the at least one 24 Vdc or 36 Vdc battery until a charging current drops to below 1 A, at which point the at least one multi-voltage charging bank is configured to indicate charging is complete.

17. A method for an on-board multi-bank marine battery charger for a recreational fishing boat having installed thereon at least one 12 Vdc battery to power marine electronics and at least one 24 Vdc or 36 Vdc battery to power a trolling motor, the multi-bank marine battery charger having a housing configured to mount on the recreational fishing boat, at least one single voltage charging bank positioned within the housing and configured to charge one of the at least one 12 Vdc battery, and at least one multi-voltage charging bank positioned within the housing and configured to charge one of the at least one 24 Vdc or 36 Vdc battery, comprising the steps of:
determining a battery voltage class of the one of the at least one 24 Vdc or 36 Vdc battery when connected thereto; and thereafter
charging he one of the at least one 24 Vdc or 36 Vdc battery at a predetermined voltage and current appropriate for the battery voltage class from the step of determining.

18. The method of claim 17, wherein the step of determining a battery voltage class comprises the steps of:
applying a constant current signal to the one of the at least one 24 Vdc or 36 Vdc battery;
measuring a voltage of the one of the at least one 24 Vdc or 36 Vdc battery after a predetermined period; and
comparing the voltage to a predetermined threshold for each battery voltage class.

19. The method of claim 18, wherein the step of determining determines that the battery voltage class is 24 Vdc when the voltage from the step of measuring is greater than 18 Vdc and less than 30 Vdc, and that the battery voltage class is 36 Vdc when the voltage from the step of measuring is greater than 30 Vdc.

20. The method of claim 17, further comprising the steps of:
sensing a voltage of the one of the at least one 24 Vdc or 36 Vdc battery;
comparing the voltage to a predetermined threshold; and
applying a current pulse to the one of the at least one 24 Vdc or 36 Vdc battery until the voltage rises above the predetermined threshold.
